(19) United States
(12) Patent Application Publication
(10) Pub. No.: US 2001/0011252 A1
(43) Pub. Date: Aug. 2, 2001

(54) INFORMATION PROVIDING SYSTEM AND INFORMATION PROVIDING METHOD

(76) Inventor: AKIHIRO KASAHARA, CHIBA-KEN (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/243,122

(22) Filed: Feb. 3, 1999

(30) Foreign Application Priority Data
Feb. 4, 1998 (JP) 23273/1998

(51) Int. Cl. G06F 17/60; H04K 1/00; H04L 9/00

(52) U.S. Cl. 705/52

(57) ABSTRACT

An information providing system according to the present invention comprises a center block 1 which totally controls all of the system, a data providing block 2 provided by each district with a prescribed range, a local control block which totally controls a plurality of shops in each district. The center block 1, the data providing block 2, and the local control block 4 send and receive various types of information via a network. When the information the customer desires does not exist in the shop 3, the shop 3 is provided the desirable information from the center block 1 and the local control block 4 via the network 5. On the occasion recording the information to the recording medium, label information relating to the information is also attached to the recording medium. Furthermore, in order to simplify search of the information, index information which is constituted by title information, introduction information, and so on is provided for the customer, and the information that the sale is limited by a law and so on of each district is excluded from the index information.

### BACKGROUND OF THE INVENTION

1. Field of the Invention

The present invention relates to a technique recording to a recording medium such as CD-R by arbitrarily selecting various types of information such as music information and image information in accordance with a request of customer.

2. Related Background Art

A system which records various types of digital information such as AV (Audio & Visual) information and game software required by the customer has been disclosed to U.S. Pat. No. 4,528,643. In the system disclosed to this document, at a booth provided for shops, the customer selects a prescribed information using a touch screen and so on, and records the selected information to the recording medium such as CD-R on the spot. When the customer requires information not being stored to an information recording apparatus, the information is provided from a master site via a network.

According to this system, the customer can fabricate the customer's own recording medium by selecting only a desirable information among a wide range of information at discretion.

Various types of the information such as music and image is a subject of protection by a copyright and an industrial property right. In order to copy such information, it is necessary to get permission from a right holder. The system disclosed in the above-mentioned document individually sells each item of information included in, for example, a music CD. Accordingly, it is necessary to get permission to individually sell each item beforehand. Furthermore, if having sold these items, it is necessary to pay a information providing fee (for example, a copyright fee) for the right holder such as a copyright holder. However, the abovementioned document does not specifically disclose how to deal with the intellectual property such as the copyright. Because of this, a right holder such as a copyright holder may not be fully protected.

When the shop does not have the information required by a customer, the above-mentioned system provides the required information for the shop via a network. However, maintenance and security of the information transmitted by the network are not considered very much in the above-mentioned document. Furthermore, on the occasion of recording the information on the recording medium, the above-mentioned system records a copy protect signal to prevent an illegal copy. However, for example, when the recording medium is damaged, or there is a necessity to exchange a part of the information, it may be necessary to permit the copy of the recording medium.

When the information required by the customer is recorded to the recording medium such as CD-R, it is desirable to attach to the recording medium a label on which a title and so on of the recorded information is described. However, it is bothersome work for the customer to attach the label to the recording medium by themselves. Furthermore, the appearance of the label may not be very good. The above-mentioned document refers to a making of the label. However, the above-mentioned document does not concretely disclose how to make a the label.

Furthermore, when there are a many types of information selectable, it may take considerable time to search a desirable information. Because of this, it is desirable to provide searching means selectable an arbitrary information easily and quickly. Furthermore, according to the type of the information, the sale of the information may be restricted by laws and customs of each selling district. The above-mentioned document does not provide the information in consideration for these specific circumstance.

### SUMMARY OF THE INVENTION

An object of the present invention is to provide an information providing system capable of recording information required by customer to a recording medium easily.

In order to achieve the foregoing object, an information providing system, comprising:

an information storing block for storing various types of information which is able to be recorded on a recording medium;

an information selecting block for selecting at least a part of the information from the information stored in said information storing block;

an information recording block for recording said selected information on the recording medium; and

an information erase determining block for determining whether or not to erase the information stored in said information storing block.

Here, “to delete” means to renew a recorded content in a RAM (Random Access Memory) and so on capable of renewing information, and to exchange the recording medium in a ROM (Read Only Memory) unable to renewing information, an optical disc and so on.

Furthermore, an information providing system, comprising:

an information storing block for encrypting and storing various types of information which is able to record on a recording medium;

an information selecting block for selecting at least a part of the information among the information stored in said information storing block;

an information recording block for recording said selected information to the recording medium;

an decryption information providing block for providing a information for decryption to decrypt said selected information; and

a frequency measuring block for measuring a frequency that said decryption information providing block has provided said information for decryption;

an information-use-frequency determining block for detecting a frequency of use of the information stored in said information storing block based on the frequency measured by said frequency measuring block, wherein

the information stored in said information storing block is possible to decrypt only once by using said information for decryption.

Furthermore, an information providing system, comprising:

an information storing block for storing various types of the information able to record to a recording medium;

an information selecting block for selecting at least a part of the information among the information stored in said information storing block;

an information recording block for recording to said recording medium said selected information; and

an index information providing block for providing an index information to discriminate the information stored in said information storing block, wherein

among the information stored in said information storing block, in terms of the information that the sale is restricted by a selling restriction including at least one among a contract between providers, the customer's age, and a selling district, said index information providing block provides said index information which clearly designates said selling restriction or said index information relating to the information except the information the sale is restricted.

According to the present invention, whether or not deleting information stored in an information storing block is determined in accordance with frequency of use of the information. Because of this, it is possible to constantly preserve in the information storing block the information that the frequency of use is high, resulting in improvement of a using efficiency of the information stored in the information storing block.

Because the present invention decrypts the information encrypted by a decryption key and then records the encrypted information in the recording medium, a security accomplishment improves. Furthermore, because the present invention permits the use of the decryption key only once, by means of measuring a frequency having sent the decryption key, it is possible to exactly and easily grasp the frequency of use of each information.

Furthermore, because the present invention generates an index information in consideration for a contract between providers, the customer's age, and a selling district, the sales of the information violating the laws are certainly prevented.

Furthermore, because the present invention judges whether or not to be a formally bought information based on a discriminate information recorded in the recording medium and then fabricates the new recording medium, it is possible to certainly prevent a copy of the recording medium for an illegal purpose.

Furthermore, because the present invention makes a label information automatically, it is possible to confirm an outline of the information being stored in the recording medium. Furthermore, if providing an aggregate block, it is possible to rightly protect a copyright holder and so on.

### BRIEF DESCRIPTION OF THE DRAWINGS

FIG. 1 is a schematic diagram of an embodiment of an information providing system according to the present invention;

FIG. 2 is a diagram explaining a connecting form of the information providing system of FIG. 1;

FIG. 3 is a diagram showing a detailed configuration in the shop;

FIG. 4 and FIG. 5 is a flowchart showing a schematic operation of an information providing system of FIG. 1;

FIG. 6 and FIG. 7 is a diagram showing an example of the index information;

FIG. 8 is a block diagram showing a hardware configuration in the shops 3 to send and receive the information to/from the center block 1 or the local control block 4 via the satellite communication;

FIG. 9 is a diagram showing an example providing an accounting block on a network.

### DESCRIPTION OF THE PREFERRED EMBODIMENTS

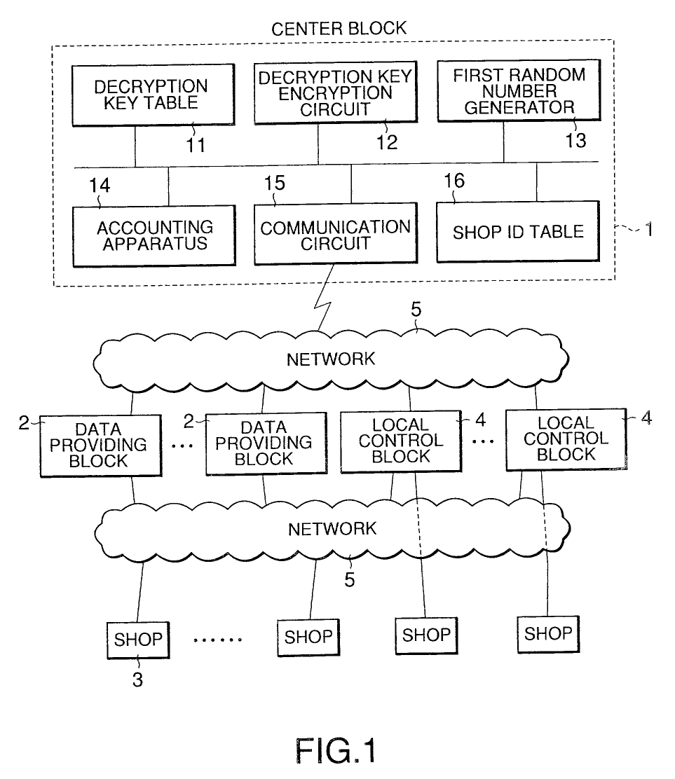

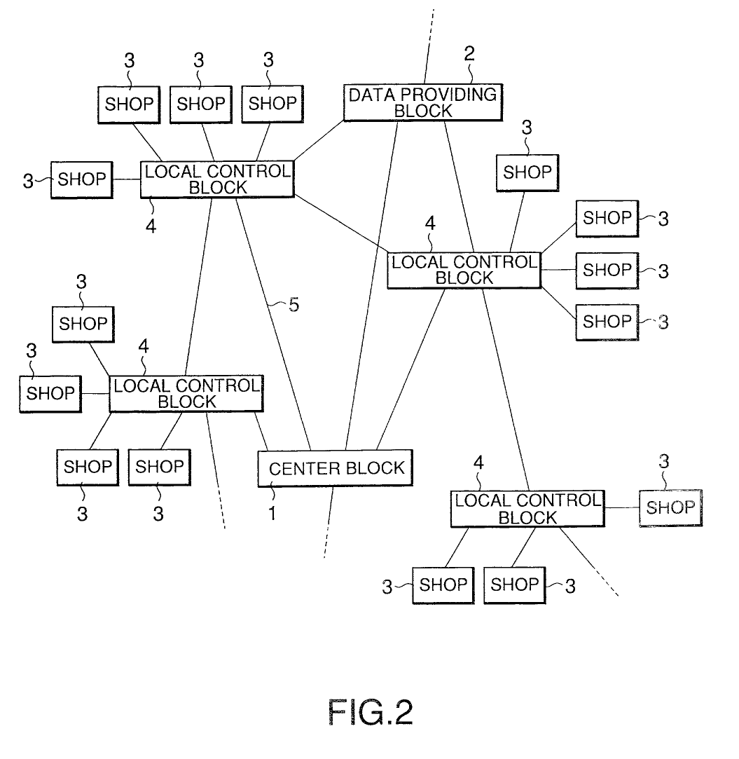

A information providing system according to the present invention is described in detail with reference to the attached drawings as follows. FIG. 1 is a schematic diagram of an embodiment of an information providing system according to the present invention. FIG. 2 is a diagram explaining a connection network for the information providing system of FIG. 1.

The information providing system according to the present embodiment comprises a center block 1 which controls all the system, a data providing block 2 provided for each district within a prescribed area, a plurality of shops provided for each district, and a local control block 4 which controls the shops 3 in each district. The center block 1, the data providing block 2, the shops 3 and the local control block 4 send and receive various types of the information via the network 5.

As shown in FIG. 2, the local control block 4 sends and receives the information to/from the shops 3 in the corresponding district via the network 5. Furthermore, in accordance with the size of the system, the center block 1 may be integrated into the local control block 4, otherwise the local control block 4 may be integrated into the data providing block 2. Otherwise, the center block 1 alone may control all the shops 3.

As shown in FIG. 1, a decryption key table 11, a decryption key encryption circuit 12, a first random number generator 13, an accounting apparatus 14, a communication circuit 15, and a shop ID table 16 are provided in the center block 1.

The decryption key table 11 stores a plurality of decryption key necessary to decryption of a code. Shop information may be used on the occasion of encrypting the decryption key. In this case, it is possible to decrypt the encrypted decryption key by using on the shop's own ID. The decryption key encryption circuit 12 encrypts the decryption key based on the random number generated by the first random number generator 13. The accounting apparatus 14 accounts for the information providing fee provided for the customer. The shop ID table 16 stores ID information individual to each shop connected to the network.

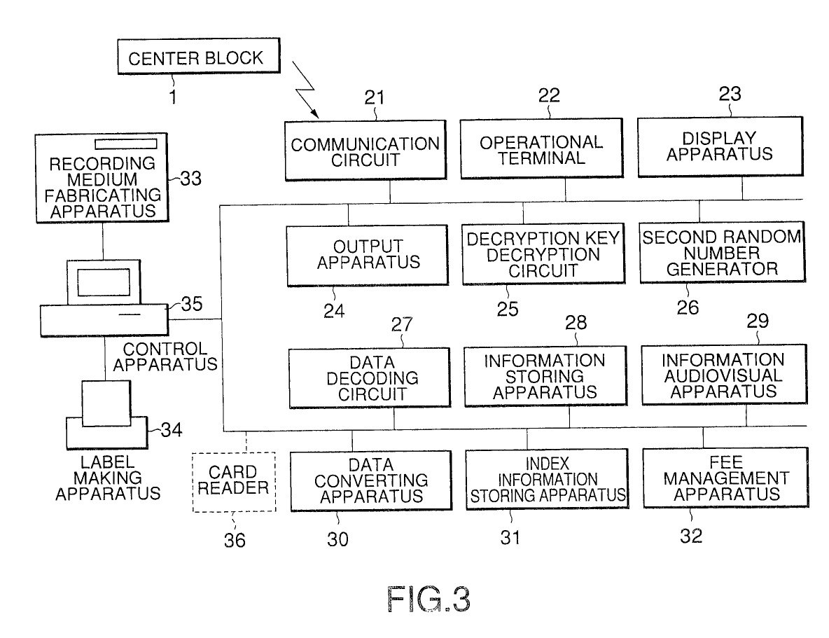

As shown in detail to FIG. 3, a communication circuit 21 which communicates with the center block 1 and so on, an operational terminal 22 which selects the information, a display apparatus 23 which displays index information and so on, an output apparatus 24 which outputs information and so on required by the customer, a decryption key decryption circuit 25 which decrypts the decryption key, a second random number generator 26 which generates the random number used for decryption of the decryption key, a data decoding circuit 27, an information storing apparatus which stores various types of the information provided by the customer, an information audiovisual apparatus 29 which provides for the customer summary information and introduction information before buying, a data converting apparatus 30 which converts the selected information to data recordable to the recording medium, an index information storing apparatus 31 which stores an index information, a fee management apparatus 32 which sums up the information providing fee (a fare charging for the customer), a recording medium fabricating apparatus 33 which controls a recording to the recording medium, a label making apparatus which makes labels to attach to the recording medium, and a control apparatus 35 which controls all the system.

The operational terminal 22 are, for example, constituted by a keyboard or a touch screen. The operational terminal 22 takes in the content designated by the customer. The display apparatus 23 displays, for example, a menu selecting window and an index information window showing a list of the information able to provide for the customer. The output apparatus 24 are, for example, constituted by a printer. The output apparatus 24 prints out various types of the information such as the information selected by the customer, the index information, and the accounting information.

The random numbers generated by the first random number generator 13 and the second random number generator 26 have the same or a prescribed rule for a certain period of time.

The decryption key decryption circuit 25 decodes the encrypted decryption key to the original decryption key by using the random number generated by said second random number generator 26.

The data decoding circuit 27 decrypts the encrypted information sent from the center block 1 by using the decryption key decoded by said decryption key decryption circuit 25.

The information storing apparatus 28 is, for example, constituted by a large capacity recording apparatus such as a hard disc drive (HDD), and a jukebox accommodating a plurality of optical discs. The information storing apparatus 28 stores various types of the information on the decrypted condition.

Because the data capacity of the information storing apparatus 28 is limited, the information often required by the customers is mainly stored.

The decryption key encryption circuit 12 corresponds to a decryption information providing block and a decryption block. The first random number generator 13 corresponds to a first random number generator. The operational terminal 22 corresponds to an information selecting block, a label attachment block, and a label type selecting block. The decryption key decryption circuit 25 corresponds to a decoding block. The second random number generator 26 corresponds to a second random number generator. The information storing apparatus 28 corresponds to an information storing block. The fee management apparatus corresponds to a aggregate block. The recording medium fabricating apparatus 33 corresponds to an information recording block and a re-recording block. The label making apparatus 34 corresponds to a label attachment block. The control apparatus 35 corresponds to an information erase judging block, a frequency count block, an information use frequency determining block, a record control block, a history information display control block, and an information providing control block. An IC card corresponds to a history information storing apparatus.

If the information required by the customer exists in the information storing apparatus in the shop 3, the shop 3 stores the information in the recording medium such as CD-R. If the information required by the customer does not exist in the information storing apparatus, the shop 3 inquires of a neighbor local control block 4. The local control block 4 searches whether or not the information inquired from the shop 3 exists in the data providing block 2 located nearby. If the information exists in the data providing block 2 located nearby, the local control block 4 reads out the information and provides the information for the shop 3. On the other hand, if the information does not exist in the data providing block 2 located nearby, the local control block 4 inquires of the other data providing block 2 or the center block 1.

The index information storing apparatus 31 stores the index information, a summary information, the introduction information, and preview information relating to the information provided for the customer on the condition not being encrypted. Hereinafter, these information is called “index information” as a generic name.

The shop 3 shown in FIG. 2 is, for example, constituted by convenience stores, restaurants such as a pizza shop, delivery shops of packages, various vending machines located at stations and so on, various shops such as record shops and bookstores, a karaoke boxes and so on.

The method selecting the information in the stores is, for example, a method selecting the information by operating the operating terminal 22 provided for the outside or the inside of the shops, a method selecting the information via various communication mediums such as a telephone, a facsimile, an Internet, and an IT (Information Technology) vision, a method that the customer orally orders at the shop, a method that a salespeople receive orders by directly visiting the customer, and so on.

When receiving orders of the customer orally or via the communication medium such as the telephone, as is the case with the karaoke or a mail order, it is desirable to provide a catalog describing a list of the information able to provide. Furthermore, before beginning the sale of the new information, a reservation may be received. If the reservation is received, it is possible to provide the information for the customer as quickly as possible after beginning the sale of the new information.

Furthermore, when setting the operational terminal 22 at the outside or the inside of the shop 3, it is desirable to provide a touch panel display such as a cash dispenser of a bank or a terminal with a voice automatic recognition function which the key operation is unnecessary.

It is desirable to always play music such as the latest hit songs and a commercial music of a hit game in this operational terminal. Furthermore, it is desirable to display images relating to the content displayed to the screen.

Furthermore, an infrared sensor or a supersonic sensor detecting existence of a person may be attached to the operational terminal 22. In this case, if the person stays for a fixed period of time within a range that the sensor can detect, the display screen may be automatically changed into a customer guidance window. Furthermore, if the sensor detects the existence of the person, the music information having been played may be stopped, and guidance information by voice, such as “May I help you” may be provided in order to attract the person's attention.

It is desirable to form the customer guidance window by a menu format and to be able to jump to the music providing window or a commercial content display window provided immediately before the customer guidance window is displayed.

It is desirable to provide at least one headphone for the operational terminal 22, and a switch, a volume controllable voice volume, or an equivalent operational member. It is desirable to provide the volume of an external speaker at the location where the customer can not touch so that the customer does not freely control the volume.

However, as is the case with a karaoke box, when only the customer being interested in the same type of information exists in the enclosed space, it is desirable to arrange the volume for volume control of the speaker at the location where the customer usually can access.

The operational terminal 22 may settle a fare and deliver a voucher. And then the customer may deliver the voucher to the clerk and receive the recording medium that desirable information has been recorded. When the information required by the customer can not be obtained at the shop, the information may be provided via the network, or delivered to the customer by a delivery service a few days afterward.

As a typical method paying the fee of the information the customer has bought, there are a loan payment by credit cards and a cash payment. If the recording medium are delivered via the delivery service, the fee may be paid when receiving the recording medium. Furthermore, it is desirable to allow the fee to interlock to a POS (Point of Sales).

There are the case the center block 1 or the local control block 4 determines the selling price and the case the shop 3 determines the selling price based on its own judgment.

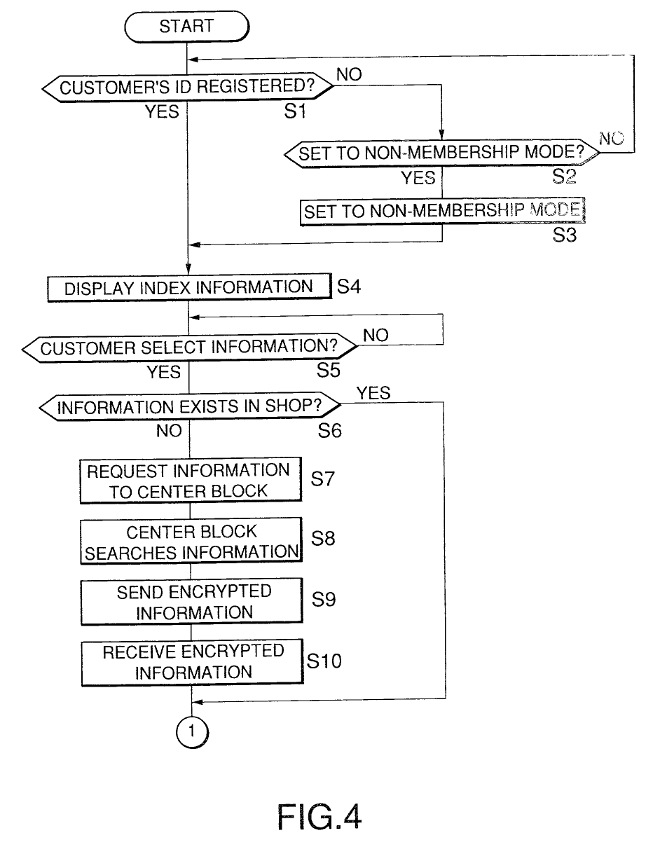

FIG. 4 and FIG. 5 are a flowchart showing a schematic operation of an information providing system of FIG. 1. This flowchart shows an example that the customer gets the information by operating the terminal provided for each of the shops 3.

The processes of the flowchart of FIG. 4 is begun when the ID card provided at each shop 3 is inserted in a card reader, and the ID of the ID card coincide with the ID already registered.

First of all, in step S1, it is judged whether or not the ID that the customer has inputted at the operational terminal 22 has already been registered is judged. Instead of inputting the ID on the customer's own, the ID check may be performed by using a card reader to read an IC or a magnetic card in which the ID information is stored.

In step S2, if the ID has been registered yet, the confirmation about whether or not a non membership mode which provides a minimum of information may be set is sought for the customer. If the customer rejects the non membership mode, the process of step S1 is performed. On the other hand, If the customer agrees on the non membership mode, the non membership mode is set, as shown in step S3.

If the process of step S1 or S3 is finished, an index information expressing a list of the information able to provide for the customer is displayed, as shown in step S4.

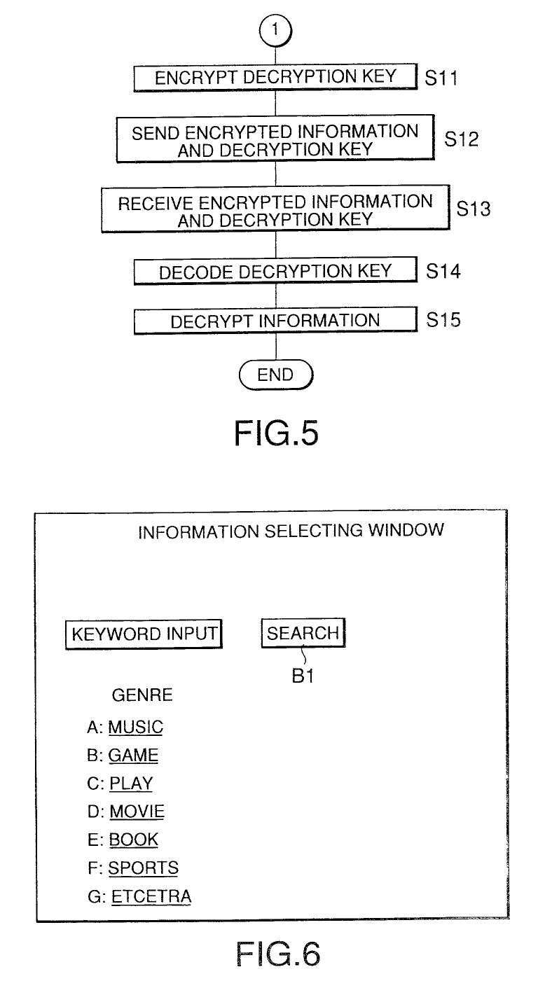

FIG. 6 and FIG. 7 are diagrams showing an example of the index information. The index information is usually constituted by a hierarchical structure. First of all, the index information of the most significant class is displayed. If the customer selects any of A-G shown in FIG. 6 by the operational terminal 22, the index information of the lower class is displayed, as shown in FIG. 7. Otherwise, the information can also be selected by pushing a search button B1 after inputting the keyword. When pushing “return” button B3 shown in FIG. 7, the index information of the next higher class is displayed. Furthermore, after inputting the keyword in the window of FIG. 6, the search button B1 may be pushed.

Next, whether or not the customer has selected the desirable information is determined, as shown in step S5. If the customer has not selected the desirable information yet, the process in step S5 is performed again. If the customer has selected the information, whether or not the selected information exists in the information storing apparatus 28 in the shops 3 is determined, as shown in step S6.

When the information selected by the customer does not exist in the information storing apparatus 28 in the shop 3, the shop 3 requires the information for the center block 1, as shown in step S7. In response to this requirement, the center block 1 reads out the information when the required information exists in the center block 1. On the other hand, when the information does not exist in the center block 1, the shop 3 inquires of the data providing block 2 and the local control block 4.

Next, the center block 1 encodes the required information and sends it to the shop 3, as shown in step S9. Next, the shop 3 which has requested the information receives the encrypted information sent from the center block 1, as shown in step S10.

Next, if it is determined that the information requested by the customers exists in the information storing apparatus 28, or if the process in step S10 has been finished, a decryption key which is necessary for the decryption of the information encrypted by the center block 1 is encrypted by using the first random number generator 13, as shown in step S11 of FIG. 5.

Here, the decryption key corresponding to the information required by the customer is referred by the decryption key table 11. The referred decryption key is encrypted by the encryption circuit 12 by using a random number such as numbers and characters outputted from the first random number generator 13. Here, the first random number generator 13 generates a new random number at regular intervals, for example, once a minute, and the process of step S9 is performed each time a new random number is generated.

Next, the customer's requesting information and the decryption key which are being encrypted are sent to the shop 3 via the network, as shown in step S12. Next, as shown in step S13, after the shop 3 has received the customer's requesting information and the decryption key which are being encrypted, the encrypted decryption key is decoded by using a random number generated by the second random number generator 26. Here, because the second random number generator 26 in the shop 3 acts in sync with the first random number generator 13 in the center block 1, the random number relating to the random number generated by the first random number generator 13 in the center block 1 is generated by the second random number generator 26 in the shop 3.

Next, the customer's requesting information is decrypted by using the decoded decryption key, and then the decrypted information is provided for the customer, as shown in step S15.

According to the preferred embodiment, there are features in terms of the types of the recording medium, the types of the provided information, an renewal of the provided information, an index information, an label making, an communication form, the decryption of the information, the accumulation of the information, an copy protect, the record to the recording medium, the sale of individual items of the information, the resale or the rental of the information, existence or nothing of the commercial information, version-up of the information provided for the customer, and a network form. Hereinafter, each of these features will be explained in order.

[The Types of the Recording Medium]

The recording medium provided for the customer may be analog recording mediums such as a cassette tape and a video tape, besides digital recording mediums such as a CD-R, a MD (Mini Disc), a PD, and a DVD-R (Digital Versatile Disc Recordable). Furthermore, The type of the recording medium may be arbitrarily selected in accordance with the customer's request. In this case, it is necessary to convert data with a format in accordance with the recording medium requested by the customer.

[The Types of the Providing Medium]

The information sold at the shop is not especially limited. The information is, for example, music information (besides data such as merchant CDs, handmade data personally made is also included), software for game machines, computer software, movie information, television information (dramas, variety shows, document programs, sports programs, news program, and so on) desirably without the commercial, the commercials of the television and the radio, book information such as the newspapers and the magazines, map information such as a car navigation, sightseeing guidance information, and so on.

Hot information is mainly stored in the information storing apparatus 28 in the shop. The reason is because it is possible to decrease the recording capacity of the information storing apparatus 28 and to reduce a facility cost of all the system. When the information required from the customer does not exit in the information storing apparatus 28, the information is provided from the data providing block 2 or the center block 1 shown in FIG. 1. Otherwise, after the latest hot data is stored in the recording medium with large capacity such as the DVD-RAM and the magnetic tape, the data may be delivered to each of the shops 3 by the delivery service by each prescribed period. In this case, the clerk of the shop 3 renews the information by setting the delivered recording medium to the information storing apparatus 28. On the occasion, so that the clerk does not go wrong the operation, it is desirable to automate a work deleting unnecessary information and a work storing the hot-selling information.

[Renewal of the Providing Information]

It costs more to deliver the new information via a recording medium with a large capacity such as a DVD-RAM than to renew the information via the network 5. Because of this, it is desirable to set a higher registration fee for the person providing the new information via the recording medium with a large capacity than the person renewing the information via the network 5. In return for this, the former person may receive a higher payment for providing the information than the latter person.

Because the hot data of the AV (Audio & Visual) information such as the music and the image changes at short time, it is desirable to provide the new information from the local control block 4 via the network periodically, for example, once per a day. The new information is stored in the information storing apparatus 28 for a prescribed period. If the frequency of use is low, the information is deleted. In principle, the center block 1 or the local control block 4 determines if deleting or not. Each of the shops 3 may determine on the shop's own if deleting or not.

In order to reduce the equipment cost, it is necessary not only to reduce the amount of data the information storing apparatus 28 stores but also to reduce the amount of data the data providing block 2 and the center block 1 stores. Because of this, each of the data providing blocks 2 and the shops 3 located nearby may own the information different from each other, and when all of them does not own the information requested from the customer, they may get the information they do not have from the other data providing block 2 and the shops 3 via the network 5 in real time. Therefore, each of the data providing blocks 2 and it is unnecessary for the shops 3 to own the same data duplicately; consequently, it is possible to reduce the equipment cost of all the system.

Because the hot data may change by each selling district, in accordance with a selling accomplishment by each selling district, the amount of data stored in each of the data providing block 2 and the shop 3 may be dynamically changed. In this case, it is desirable to select the amount of data by setting a time as a weight function. Generally, because the communication fee changes in accordance with a transmitting distance, in consideration for the communication fee, the amount of data stored in each of the data providing block 2 and the shops 3 may be distributed.

[Index Information]

The index information showing a list of the selectable information is displayed on the display apparatus (not shown) of the information audiovisual apparatus 29 in the shop 3 shown in FIG. 3. When the new information is provided, the index information is renewed. For example, as is the case with AV information, newspaper information and so on, when the new information is provided, it is desirable to renew the index information periodically, for example, at least once per a day. When renewing the index information, only a differential information may be sent via the network 5. Otherwise, when the total amount of the index information is a little, all the information may be interchanged.

Furthermore, the new information and the latest information may be delivered to each of the shops 3 by the delivery service and so on. Otherwise, the serial number information and the index information to discriminate the information recorded to the recording medium may be sent via the network 5, and the content of the information may be delivered to the shops 3 and the customer by the delivery service and so on.

There is a case where it is unable to clearly determine only by index information such as a title whether or not the information should be selected. Because of this, it is desirable to be able to see and to hear the index information that includes the introduction information, the summary information and so on. In this case, it is necessary to provide AV apparatuses such as a headphone, a speaker, and a display apparatus.

It is desirable to provide a search engine similar to a homepage search on the Internet so as to be able to search for the desirable information. Furthermore, it is desirable to provide many kinds of search function such as a genres search function, a keywords search function, and an authors search function. Music information may be searched for by extracting, with a voice recognition function, characteristics of phrases and rhythms that the customer have inputted through a microphone.

Furthermore, when a plurality of the information, which are the same type, have been detected, it is desirable to display in order that the frequency of use is high. Furthermore, as is the case with the game software, when a large amount of the sales is anticipated, regardless of the accomplishment of the sales, the display priority rank may be raised in advance.

Furthermore, because the hot-selling information may be different by each of the districts and the shops 3, after sending the accomplishment of the sales by each of the shops 3 to the local control block 4 or the center block 1, the center block 1 and so on may sum up the accomplishment of the sales and determine the priority to display. Otherwise, the priority to display may be determined by each of the districts and the shops 3.

Because there may be the information the selling district is limited, the information relating to the district being able to sell and the affiliated shops may be included in the index information. In the district the sales are inhibited and the shops 3 except the affiliated shops, a part of the index information may be partially restricted. When the range that the sales are restricted is broad, for example, when the sales are restricted in all of a prefecture or a country, an individual index information may be made by each of the districts.

It is desirable to translate the index information into a plurality of languages in advance, and to provide the index information by using the language usually used at each district. In accordance with the request of the customer, it may be able to change into the other language.

In the information sold, as is the case with a sexual or violent description, there is the information the sales are limited, for example, by the law, the custom of each district, or by a contract between sellers. Because of this, it is desirable to display the index information in consideration for the law and the custom. For example, for the customer that the purchase of a certain type of the information is not permitted, it is desirable not to provide the index information relating to the certain information. Otherwise, when displaying the index information, it is desirable to emphatically display items limiting the sales in order to call the customer's attention.

Furthermore, in order to abide by a selling arrangement of the information, at the register and so on of each of the shops 3, the check may be performed by the membership card, the credit card and so on of the customer. Though the check may be perform by the clerk of the shop 3, may be automated. When being unable to judge adequately by these cards, the sales may be inhibited, or the exhibition of an identification card may be sought.

The judgement whether or not to permit the sales of various types of the information included to the index information is performed by the center block 1 managing each shop 3 and the local control block 4, on the occasion the latest index information has been made. In accordance with this judging result, each shop 3 sells the information for the customer.

[Label Making]

The label making apparatus 34 shown in FIG. 3 makes the label on which a title of the information recorded to the recording medium, an image information attached to the title, the information the customer desires and so on is described. This label is automatically attached to the recording medium the information ordered by the customer is recorded. Otherwise, only the label may be separately delivered to the customer.

When the recording medium is the shape of a disc such as the CD-R, it is desirable to attach a label seal with the shape of a donut. When adding or deleting a part of the information recorded to the recording medium, it is desirable to use a seal member made of an adherent material capable of easily stripping off so as to be able to easily exchange the label.

It is desirable to print the information such as a serial number and a selling day so that these information can be recognized by the customer's own eyes. Therefore, it is possible to easily determine whether or not the recording medium has been bought with a formal route; consequently, it is possible to surely prevent the illegal copy for the wrong purpose. A discriminate image such as the bar code may be printed in the label.

Furthermore, the label is not limited to that with the shape of a sheet. For example, an ink material printed to a transcript paper may be transcribed into the outside surface of the recording medium by heat and so on. Otherwise, by using a sublimate type of a printer, the characters and so on may be directly transcribed into the recording medium. In this case, it is further desirable that the base color of the disc is white of a haze, because chromogenic capability is good.

Furthermore, a label for a case which accommodates the recording medium may be made. In this case, a special paper should be used for such a label that is of a size suitable for the case and has cutting lines at prescribed positions. After printing the information such as the title by using the printer and so on, the paper is cut at the cutting line and embedded in the case.

It is desirable to set a actually printed region to a little bigger area than the size of the specific paper. Furthermore, it is desirable to provide a crease or the cutting line by a specific punching apparatus at the cut location so as to be able to easily cut off the specific paper after printing.

Furthermore, it is desirable to print the attached printed matter such as a song card on a paper with the crease so as to be able to easily fit in the case.

The notice in that the adult is a target and the notice in terms of the copyright holder may be described in the label. Therefore, it is possible to obviate the sales of the adult movie video for a minor.

Because there are the customer who think the label is unnecessary, it may be able to select whether or not to make the label at discretion. When not making the label, the selling fee may be reduced. The customer may select one or more of the information among a plurality of the information and the image which are able to print on the label.

[Communication Form]

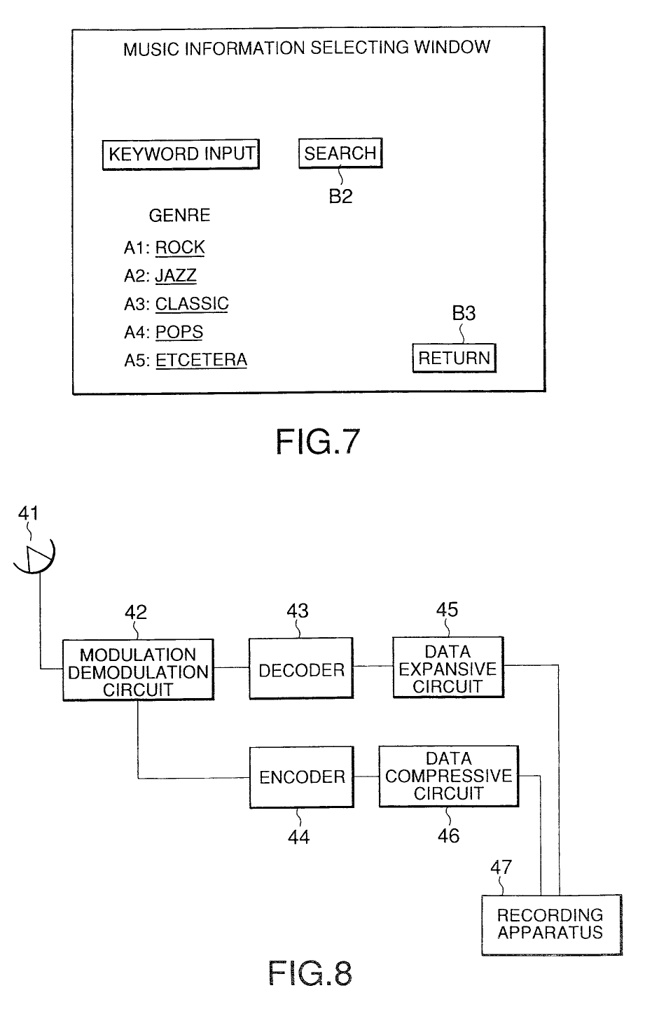

The network according to the preferred embodiment may be constituted by an ISDN line or a wireless communication such as a satellite communication. FIG. 8 is a block diagram showing a hardware configuration in the shops 3 to send and receive the information to/from the center block 1 or the local control block 4 via the satellite communication. As shown in FIG. 8, instead of the communication apparatus 18 shown in FIG. 3, a satellite antenna 41, a modulation/demodulation circuit 42, a decoder 43, a encoder 44, a data expansive circuit 45, and a data compressive circuit 46 are provided in the shop 3. Because anyone can receive radio waves from a satellite if there is the satellite antenna 41, it is desirable to transmit the encrypted information in order to maintain security. After the data received by the satellite antenna 41 is demodulated by the demodulating circuit 42, the demodulated data is decrypted by the decoder 43. The decrypted data is reconstructed to the original information by the data expansive circuit 45, and then is stored in the recording apparatus 47. This recording apparatus 47 corresponds to the data providing block 2 in FIG. 1 and an information storing apparatus 28 in FIG. 3.

On the other hand, the information sent from the shop 3 to the center block 1 and so on is compressed by the data compressing circuit 46 in order to reduce the amount of data, and then is encrypted by the encoder 44. The encrypted data is transferred to the modulation signal and then is sent from the satellite antenna 41.

[Encryption]

As a method of the encryption, there is a method which sends the decryption key available only once from the center block 1 or the local control block 4 and decrypts the encrypted information at the shops 3 by using this key.

Here, when a request for a prescribed information is sent from the shops 3 to the center block 1 or the local control block 4, the decrypted key necessary to decryption of only the requested information is sent from the center block 1 or the local control block 4 only to the shop 3 which has requested the information.

The decryption key should be highly secure. Because of this, as far as the decryption key is concerned, it is preferable to use a “one-to-one” communication system such as through telephone lines, as it offers better security than a “one-to-many” communication system such as through satellite communication.

Furthermore, as a concrete method of the encryption, various types of the information encrypted is stored in the data providing block 2 in FIG. 1 and the information storing apparatus 28 in FIG. 3, and the information decrypted by using the decryption key is stored in the recording medium.

Therefore, if not having the decryption key, because it is impossible to decrypt the encrypted information, the security capability is improved. Furthermore, when recording to the recording medium, if recording the copy protect signal, the security capability is more improved. Furthermore, because it is possible to use the decryption key only once, it is possible to exactly grasp the frequency of use of each information by counting the frequency that the center block 1 and the local control block 4 send the decryption key to each shop 3. The decryption key is applicable to not only the case performing a wireless communication, but also the case performing a wired communication via a network shown in FIG. 1.

[Storing of the Information]

The center block 1 or a data management company not shown performs the process storing various types of the information in the data providing block 2 in FIG. 1 or the information storing apparatus 28. Because the customer requests various kinds of request, it is desirable to store as much information as possible, as long as there is room to store data. Furthermore, the information of various databases provided via the Internet may be also provided for the customer.

Furthermore, on the condition filling a prescribed standard, the service registering the music tape and so on that the amateur band and so on personally produced may be provided. In this case, the calculation of the charge is performed in accordance with the amount of the information and the registered period. The customer pays the information providing fee such as a copyright fee for the right holder such as the copyright holder in accordance with the amount of the sales.

In terms of the amount paid to the registered person, several options may be provided such as the following (1) and (2).

(1) Instead of cheapening the register fee (carrying charge), the information providing fee is also cheapened.

(2) Instead of raising the register fee (carrying charge), the information providing fee is also heightened.

[Copy Protect]

The information recorded on the recording medium such as CD-R can easily be copied unless a copy protection system is used. Because of this, it is desirable to record a copy protect signal such as a watermark when recording the information to the recording medium. Otherwise, a copy protect signal may also be included in each item of information to be recorded so that the information may be recorded onto a recording medium only with a specific recording device.

Otherwise, a illegal selling protect information different from the copy protect signal may be included on the encrypted form in each of the selling information. In this case, as far as there is no decryption key provided for only a formal user, the record to the recording medium may be inhibited. Therefore, it is possible to protect an illegal copy when performing the version-up of the software and so on.

As a concrete example of the information protecting the illegal sale, for example, a serial number may be written at a prescribed location of the recording medium. If the serial number is written at a plurality of locations, it is further desirable because a redundancy capability improves. Furthermore, the serial number may be encrypted.

As is the case with the CD-R, the MD and so on, for the recording medium that a copy including the same digital signal as that of an original data such as a music CD format is not permitted, it is desirable to add an inherent header information or an error correction code to the original signal, and then after performing an interleave, a signal modulation and so on, to perform the record to the recording medium.

Furthermore, for the recording medium such as MO that a copy by the same digital signal as the original signal is being permitted, it is desirable to add the inherent header information or the error correction code to the original signal, and then after performing an interleave, a signal modulation and so on, and then further to add the copy protect signal, and then to perform the record to the recording medium.

When recording the music information and so on to an analog recording medium such as an analog tape, after performing a D/A conversion for the information read out from the information storing apparatus 28 and so on, in accordance with the customer's request, the noise reduction process such as a Dolby system is performed, and then the record to the recording medium is performed.

When recording an analog image signal to the recording medium such as an analog video tape, it is desirable to be able to select an SVHS method or an ordinary VHS method, and it is further desirable to record on the condition adding the copy protect signal.

[Record to Recording Medium]

It is desirable to record the information to a recording medium with more accuracy than a prescribed standard by performing verifiability when recording to the recording medium. Furthermore, if providing a multihead which performs the verifiability at the same time when recording, it is possible to shorten the recording time. On this occasion, if using the recording apparatus capable of recording at high-speed rotation, it is possible to further shorten the customer's waiting time (for example, within three minutes).

Furthermore, when the recording medium fabrication apparatus 33 in FIG. 3 records the information to the recording medium, if unable to record correctly, the recording medium may be automatically exchanged.

Furthermore, in order to effectively use the recording medium, a new information may be able to additionally record an additional information to an empty region in the recording medium. A compressive data may be stored in the information storing apparatus 28, and after expanding the compressive data, the record to the recording medium may be performed. Furthermore, because the image information and the voice information have a large amount of data, after compressing with compressive format the customer desires, the record to the recording medium may be performed.

Furthermore, because a recording medium such as a CD-R can stamp a pre-pit signal corresponding to a specific information, for example, the information such as the selling shop, the selling country, and the selling year at the inside edge or the outside edge of the recording medium. The pre-pit signal may be able to recognize or unable to recognize. Furthermore, the copy protect measure may be performed by using the pit signal.

The recording medium such as CD-R sometimes causes a read error. On the occasion, it is desirable to provide a new recording medium for a formal buyer. However, in order to protect the illegal copy, it is desirable to record the ID of the customer to the label and so on of the original recording medium and to permit a re-record only when the ID of the customer coincides with the ID of the customer owning the recording medium which has caused the read error.

The information the customer requires may not be able to be stored in the recording medium because of an overcapacity. Because of this, it is desirable to check a compatibility before recording to the recording medium and to alarm by an error message and so on if unable to record in the recording medium.

[Sale of Individual Items of the Information]

When selling the music information in the shop 3, it is desirable to select an arbitrary tune from a merchant disc such as the music CDs and to make the customer's own album. Because of this, it is desirable to annex an administration number to each tune of the selling disc and to administer each tune with a subnumber such as “12345-1” or “12345-2”.

Because the sale of the individual items of the information may cause the trouble on the copyright, it is desirable to perform the sale of only the individual items of the information that the permission of the copyright holders has been obtained.

[Resale or Rental of the Information]

The service reselling the information sold once may be provided. That is, as is the case with rental videos and rental CDs, the information that the customer desires may be rented only for a prescribed period. In this case, the recording medium may use either of the customer's own one or the shop's own one. In the treatment on the copyright, because the sale of the information is different from the rental of the information, it is necessary to get permission of the copyright holder in advance. The fee in the case selling the information may be different from that in the case renting the information.

The shop 3 which refunds or erases the information may be different from the shop 3 which rents the information. In this case, it is desirable to develop a system for transferring, from the shop 3 that rent the data to the customer to the shop 3 that the customer has returned the data, a certain amount of money corresponding to the refund to the customer, or it is desirable to incorporate into a settling system such as a POS system having the similar function to the above-mentioned system.

Furthermore, a service which deletes a part or all of the recorded information may be provided. When having deleted, a part of the selling price may be cashed back in accordance with the period used by the customer. Otherwise, if recording the new information to the recording medium instead of the deleted information, a cutting price may be set.

[Existence or Nothing of the Commercial Information]

When selling a certain television program information, either of the information including the commercial or the information not including the commercial may be able to select. That is, among the customers, because there are the customers who desire to be provided with the program only and the customers who desires to be provided as cheaply as possible, regardless of the content of the information.

Furthermore, the information besides the television programs, for example, the AV information and the game software may be sold on the condition including the commercial information. For example, a temporary version of a new game may be included to the game software. Otherwise, a preview of a new movie may be included to the movie information. When including the commercial information, if the provider of the commercial information burdens a part of the copyright fee and so on, it is possible to set the providing price cheaply.

[Version up of the Information]

When the version of the computer software ups, the recording medium of the previous version becomes unnecessary. Because of this, the service which retrieves an unnecessary recording medium may be performed. In this case, the retrieved recording medium may be returned to the copyright holder or be scrapped. Furthermore, a little money may be cashed back for the customer which has returned the recording medium. Otherwise, a new version of the recording medium may be provided at a cheap price.

Thus, when the return of the information, the version-up, or an upgrade is performed, and further when a renewable recording medium is used, it is desirable to erase the unnecessary information in the recording medium immediately after the return of the information, the version-up, or an upgrade is performed. On the other hand, when an unrenewable recording medium is used, it is possible to prevent an illegal use of the abandoned information, by preventing a replay of data in the recording medium.

Furthermore, in the computer software, the car navigation information and so on, there is the case the version-up is performed based on differential information. In this case, by referring to the serial number and the version of the recording medium at this point, only when having confirmed to be a formal buyer, the differential information able to upgrade to the new information may be provided.

Thus, according to the information providing system shown in FIG. 1-FIG. 8, it is unnecessary for each of the shops 3 to own a large amount of the information. Furthermore, the information never sell out, and it is possible to provide the desirable information for the customer at shorter time. Furthermore, if sending and receiving the information via the network 5, it is possible to substantially reduce the delivery cost of the information. Furthermore, even if the recording medium damages and the replay is impossible, it is possible to protect the illegal copy and to fabricate a formal reproduction easily at a cheap cost, and further to provide for the customer easily, even if a request of the information is very few.

[Network Form]

The form of the network is not limited to that shown in FIG. 1. It is possible to use various types of communication lines such as a LAN line, a telephone line, a telegram line, a line exchanging line, a packet exchanging line, a frame relay line, a cell relay line, and an ISDN line. For example, if the scale of the network is small, the LAN line, the telephone line and so on may be used, if the scale of the network is large and it is necessary to communicate a large amount of data at high speed, the communication may be performed by using an ATM (Asynchronous Transfer Modes) exchange via the cell relay exchanging line. It is possible to use various types of lines such as a copper line, a coaxial line, an optical cable and so on. Furthermore, a wireless communication via a microwave or a millimetric wave may be performed.

[Summing-up of the Information Providing Fee]

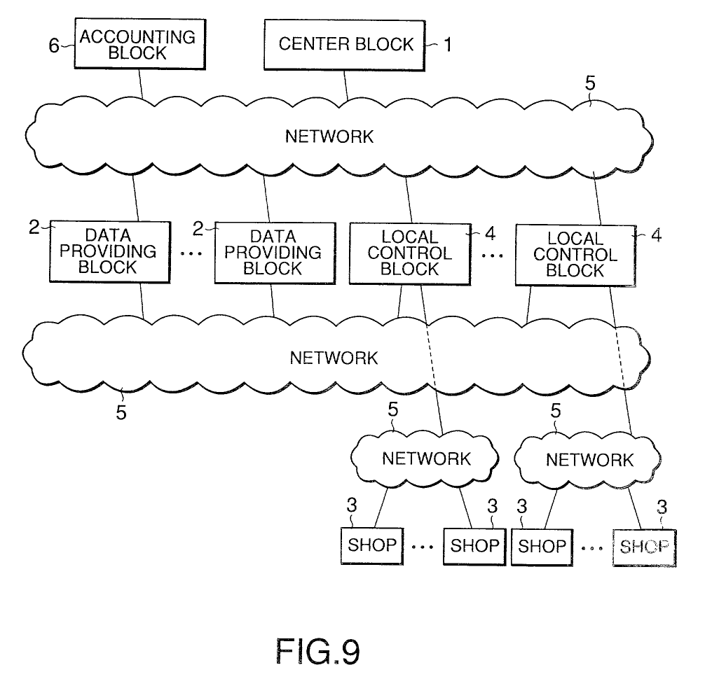

As shown in FIG. 3, the fee management apparatus 32 is provided in the shop 3. The fee management apparatus 32 calculates a charge for the customer. The charge is summed up at the local control block 4 in FIG. 1 or the center block. Otherwise, as shown in FIG. 9, an accounting block which sums up the selling accomplishment of each shop 3 may be provided on the network 5, aside from the center block 1 and so on. Furthermore, the accounting block 6 may be linked to the POS system provided for each shop 3, and may inform the center block 1 and the local control block 4 of the summing-up result in real time.

[Storing of the History Information]

In step S1 in FIG. 4, when checking the ID of the customer, the ID may be checked by using an IC card that the ID information of the customer and the type of the information which has been provided for the customer before (hereinafter, called a history information) have been recorded.

More detailedly, when such kind of the IC card is inserted into the card reader 36 in the shop 3 shown at a dotted line in FIG. 3, the control apparatus in FIG. 3 reads out the history information and then displays the information to the display apparatus 23. Therefore, the customer can confirm the information provided before.

Furthermore, the control apparatus 35 in FIG. 3 judges the customer's liking based on the history information read out from the IC card, selects the information the customer seems to prefer, and displays to the display apparatus 23 the index information corresponding to the selected information. Therefore, it becomes unnecessary for the customer to select the index information on the customer's own, and the customer can surely obtain the latest information that the customer desires without missing.

[Other Modified Example]

Only one center block 1 is being provided in FIG. 1. A plurality of center blocks 1 which provides the information different from each other may be provided. For example, the center block 1 which provides music data owned by A company and the center block 1 which provides music data owned by B company may be provided, and the information provided from the two center blocks 1 may be transferred to the data providing block 2, the shops 3 and so on.

What is claimed is:

1. An information providing system, comprising:
an information storing block for storing various types of information which is able to be recorded on a recording medium;
an information selecting block for selecting at least a part of the information from the information stored in said information storing block;
an information recording block for recording said selected information on the recording medium; and
an information erase determining block for determining whether or not to erase the information stored in said information storing block.

2. The information providing system according to claim 1, further comprising:
an aggregate block for summing up an information providing fee which should be paid to a right holder or a provider of each information recorded on the recording medium.

3. An information providing system, comprising:
an information storing block for encrypting and storing various types of information which is able to be recorded on a recording medium;
an information selecting block for selecting at least a part of the information from the information stored in said information storing block;
an information recording block for recording said selected information on the recording medium;
a decryption information providing block for providing a information for decryption to decrypt said selected information; and
a frequency measuring block for measuring a frequency that said decryption information providing block has provided said information for decryption;
an information-use-frequency determining block for detecting a frequency of use of the information stored in said information storing block, based on the frequency measured by said frequency measuring block, wherein
the information stored in said information storing block is decrypted only once by using said information for decryption.

4. The information providing system according to claim 3, further comprising:
a wired or wireless network for transferring data among a plurality of shops and a center block which totally controls all of said shops,
said center block including a first random number generator for generating a random number, and an encryption block for encrypting said information for decryption by using the random number, and
each of said shops including a second random number generator for generating a random number in sync with said first random number generator, and a decryption block for decrypting said information for decryption encrypted by said encryption block by using the random number generated by said second random number generator.

5. The information providing system according to claim 3, further comprising:
a wired or wireless network for transferring data between a plurality of shops and a center block for controlling all of said shops, wherein
when the information required by the customer does not exist in said plurality of shops, each of the shops receives the corresponding information via said network from the other shops or said center block.

6. An information providing system, comprising:
an information storing block for storing various types of information which is able to recorded on a recording medium;
an information selecting block for selecting at least a part of the information from the information stored in said information storing block;
an information recording block for recording said selected information on said recording medium; and
an index information providing block for providing an index information to discriminate the information stored in said information storing block, wherein
if there is any information of which the sale is restricted due to sales restrictions such as restrictions by a contract between providers, the customer's age, and statutes for a certain area, said index information providing block provides said index information clearly designating said sales restrictions, or simply omitting said sales restrictions.

7. The information providing system according to claim 6, comprising:
a wired or wireless network for transferring data between a plurality of the shops and a center block for totally controlling all of the shops, wherein
said index information providing block sums up the selling amount of the information by each of selling districts or by each of the shops, and provides said index information relating to a hot-selling information based on the summing-up result.

8. The information providing system according to claim 7, wherein
said index providing block sets a displaying order of said index information based on said hot-selling information.

9. The information providing system according to claim 6, wherein
said index providing block provides at least either of summary information indicating an outline of each item of information included in said index information or introduction information which is a part of each information included in said index information.

10. The information providing system according to claim 1, further comprising:
a re-recording block for recording on a separate recording medium the same information as the information recorded on the recording medium, or information relating to the information recorded on the recording medium, wherein
when recording on the recording medium the information selected by said information selecting block, said information recording block records on the recording medium a discriminating information indicating that the recording medium has been bought formally, and
said re-recording block records the designated information only when said discriminating information is recorded on the recording medium.

11. The information providing system according to claim 10, further comprising:
a recording control block for permitting a re-record for at least either one of said information recording block or said re-recording block, when the record to the recording medium has not been recorded onto correctly.

12. The information providing system according to claim 10, comprising:
a label attachment block for generating a label including information relating to the information recorded on the recording medium and attaching the label at a prescribed position to the recording medium.

13. The information providing system according to claim 12, further comprising:
a label existence or nothing selecting block for selecting whether or not to attach the label to said recording medium; and
a label type selecting block for selecting a type of the label attached on the recording medium, wherein
said label attachment block attaches on said recording medium the type of the label selected by said label type selecting block, when said label existence or nothing selecting block selects the attachment of the label.

14. The information providing system according to claim 1, further comprising:
a history information storing apparatus for storing a history information provided for the customer and which can be carried;
a history information display control block for allowing the history information being stored in said history information storing apparatus to be displayed on said display apparatus.

15. The information providing system according to claim 14, further comprising:
an information providing control block for reading out from said information storing block an information relating to the history information stored in said history information storing apparatus, and providing the information for the customer.

16. An information providing method, comprising:
a step for storing various types of information which is able to be recorded on a recording medium;
a step for selecting at least a part of the information from the information stored in said information storing block;
a step for recording said selected information on the recording medium; and
a step for determining whether or not to erase the information stored in said information storing block.

17. The information providing method according to claim 16, further comprising:
a step for providing a information for decryption to decrypt a prescribed information;
a step for measuring a frequency that said decryption information providing block has provided said information for decryption;
a step for detecting a frequency of use of the information stored in said information storing block based on the frequency measured by said frequency measuring block, wherein
the information stored in said information storing block is decrypted only once by using said information for decryption.

18. The information providing method according to claim 16, further comprising:
among the information stored in said information storing block, in terms of the information that the sale is restricted by a selling restriction including at least one among a contract between providers, the customer's age, and a selling district, said index information providing block provides said index information which clearly designates said selling restriction or said index information relating to the information except the information the sale is restricted.

19. The information providing method according to claim 16, further comprising:
a step for recording to the recording medium said discriminating information and a discriminating information designating that the recording medium has been bought formally; and
a step for recording to a separate recording medium the same information as the information recorded to the recording medium, or information relating to the information recorded to the recording medium, as far as said discriminating information is being recorded in the recording medium.

20. The information providing method according to claim 16, wherein
a history information corresponding to the information provided for the customer is stored in a history information storing apparatus which can be carried, and
the history information which is being stored in said history information storing apparatus and corresponds to the information provided for the customer is displayed to a display apparatus.
